(19) United States
(12) Patent Application Publication
(10) Pub. No.: US 2022/0156118 A1
(43) Pub. Date: May 19, 2022

(54) INFORMATION PROCESSING DEVICE, INFORMATION PROCESSING METHOD, RECORDING MEDIUM IN WHICH INFORMATION PROCESSING PROGRAM IS RECORDED, AND INFORMATION PROCESSING SYSTEM

(71) Applicant: TOYOTA JIDOSHA KABUSHIKI KAISHA, Toyota-shi (JP)

(72) Inventor: Toru FURUSAWA, Yokohama-shi (JP)

(73) Assignee: TOYOTA JIDOSHA KABUSHIKI KAISHA, Toyota-shi (JP)

(21) Appl. No.: 17/514,586

(22) Filed: Oct. 29, 2021

(30) Foreign Application Priority Data
Nov. 17, 2020 (JP) 2020-191197

(51) Int. Cl. G06F 9/50; H04L 29/08

(52) U.S. Cl. CPC G06F 9/5027; G06F 2209/5015; H04L 67/12

(57) ABSTRACT

An information processing device acquires a first time representing processing time in a case in which a container application has been executed by an on-board unit and acquire second times in regard to each of a plurality of servers communicable with the on-board unit, each of the second times being calculated from a sum of processing time in a case in which the container application has been executed by a server and round-trip time required for round-trip communication between the on-board unit and the server. The information processing device identifies a shortest time from the second times in regard to each of the plurality of servers and the first time of the on-board unit and perform control to execute the container application in a device corresponding to the shortest time.

### CROSS-REFERENCE TO RELATED APPLICATION

This application is based on and claims priority under 35 USC 119 from Japanese Patent Application No. 2020-191197 filed on Nov. 17, 2020, the disclosure of which is incorporated by reference herein.

### BACKGROUND

### Technical Field

This disclosure relates to an information processing device, an information processing method, a recording medium in which an information processing program is recorded, and an information processing system.

### Related Art

Conventionally, technologies that use container technology to manage applications have been known.

Japanese Patent Application Laid-open (JP-A) No. 2019-66926 discloses a technology that uses container technology to manage applications of an on-board unit. Specifically, JP-A No. 2019-66926 discloses that a container control agent running on a car operating system (OS) deploys a container image acquired via the Internet to a container application on the car OS and starts.

Furthermore, JP-A No. 2019-149192 discloses a system that runs one or plural containers in order to execute tasks based on task definitions.

In this connection, application programs (hereinafter simply called “applications”) for vehicles sometimes need real-time responsiveness. For example, sometimes the processing time required from start to completion of the execution of applications for vehicles needs to be within a predetermined amount of time. For this reason, when an application is executed on an on-board unit, it is necessary to consider the processing time required from start to completion of the execution of the application. On the other hand, when an application is executed on an external server, communication between the on-board unit and the external server occurs, so it is necessary to consider not only the processing time of the application but also, added to that, the communication time between the on-board unit and the server.

JP-A No. 2019-66926 discloses only that the container image acquired via the Internet is deployed to the container application on the car OS and starts, and does not consider the processing time of the container application and the communication time between the vehicle and the server. Furthermore, JP-A No. 2019-149192 discloses only a system that runs containers based on task definitions, and, as with JP-A No. 2019-66926, does not consider the processing time of the container application and the communication time between the vehicle and the server.

For this reason, the conventional technologies of JP-A No. 2019-66926 and JP-A No. 2019-149192 have the problem that they cannot shorten the time required to obtaining processing results of a container application in consideration of the processing time of the container application and the communication time between a vehicle and a server.

### SUMMARY

This disclosure shortens the time required to obtain processing results of a container application in consideration of processing time required for execution of the container application and round-trip time required for round-trip communication between a vehicle and a server.

An information processing device of a first aspect includes: an acquisition unit that acquires a first time representing processing time in a case where a container application has been executed by an on-board unit and acquires second times in regard to each of a plurality of servers communicable with the on-board unit, each of the second times being calculated from the sum of processing time in a case where the container application has been executed by the server and round-trip time required for round-trip communication between the on-board unit and the server; and a control unit that identifies the shortest time from the second times in regard to each of the plurality of servers and the first time of the on-board unit and performs control to execute the container application in the device corresponding to the shortest time.

The control unit of the information processing device of a second aspect performs control to stop the container application in each of the devices different from the device in which the container application is executed.

The control unit of the information processing device of a third aspect, each time a predetermined amount of time elapses, acquires the first time and each of the second times and performs control to execute the container application in the device corresponding to the shortest time.

The control unit of the information processing device of a fourth aspect acquires the round-trip time of each device by requesting the round-trip time from each device and thereafter uses the round-trip time of each device to calculate the first time and the second times.

An information processing method of a fifth aspect is a method whereby a computer executes a process to: acquire a first time representing processing time in a case where a container application has been executed by an on-board unit and acquire second times in regard to each of a plurality of servers communicable with the on-board unit, each of the second times being calculated from the sum of processing time in a case where the container application has been executed by the server and round-trip time required for round-trip communication between the on-board unit and the server; and identify the shortest time from the second times in regard to each of the plurality of servers and the first time of the on-board unit and perform control to execute the container application in the device corresponding to the shortest time.

A sixth aspect is a recording medium in which is recorded an information processing program for causing a computer to execute a process to: acquire a first time representing processing time in a case where a container application has been executed by an on-board unit and acquire second times in regard to each of a plurality of servers communicable with the on-board unit, each of the second times being calculated from the sum of processing time in a case where the container application has been executed by the server and round-trip time required for round-trip communication between the on-board unit and the server; and identify the shortest time from the second times in regard to each of the plurality of servers and the first time of the on-board unit and perform control to execute the container application in the device corresponding to the shortest time.

A seventh aspect is an information processing system including an on-board unit and a plurality of servers communicable with the on-board unit, wherein: the on-board unit outputs, to a cloud server among the plurality of servers, a first time representing processing time in a case where a container application has been executed by the on-board unit; each of the plurality of servers outputs, to the cloud server, a second time calculated from the sum of processing time in a case where the container application has been executed by the server and round-trip time required for round-trip communication between the on-board unit and the server; and the cloud server acquires the first time of the on-board unit and the second times in regard to each of the plurality of servers, identifies the shortest time from the second times in regard to each of the plurality of servers and the first time of the on-board unit, and performs control to execute the container application in the device corresponding to the shortest time.

As described above, according to this disclosure, the disclosure has the advantageous effect that it can shorten the time required to obtain processing results of a container application in consideration of processing time required for execution of the container application and round-trip time required for round-trip communication between the vehicle and the server.

### BRIEF DESCRIPTION OF THE DRAWINGS

FIG. 1 is a drawing for describing an embodiment of this disclosure;

FIG. 2 is a drawing for describing the embodiment;

FIG. 3 is a drawing for describing the embodiment;

FIG. 4 is a schematic block diagram of an information processing system pertaining to the embodiment;

FIG. 5 is a drawing showing an example configuration of a computer for realizing each device pertaining to the embodiment;

FIG. 6 is an example of a sequence performed by the information processing system pertaining to the embodiment;

FIG. 7 is an example of a sequence performed by the information processing system pertaining to the embodiment;

FIG. 8 is an example of a sequence performed by the information processing system pertaining to the embodiment;

FIG. 9 is an example of a sequence performed by the information processing system pertaining to the embodiment;

FIG. 10 is an example of a sequence performed by the information processing system pertaining to the embodiment; and

FIG. 11 is an example of a sequence performed by the information processing system pertaining to the embodiment.

### DETAILED DESCRIPTION

<Embodiment>

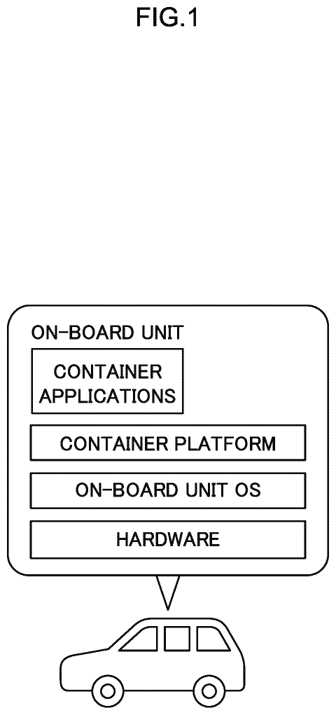

FIG. 1 to FIG. 3 are drawings for describing an embodiment of this disclosure. As shown in FIG. 1, consider a case where a container is disposed in an on-board unit mounted in a vehicle and containerized application programs (hereinafter simply called “container applications”) are executed in the on-board unit. In this case, the on-board unit includes a container platform for executing the container, an on-board unit OS representing an operating system of the on-board unit, and hardware. The container platform and the on-board unit OS are realized by software. Examples of processes that the container applications execute include a process to track objects appearing in images captured by an on-board camera.

When a container application is executed in the on-board unit, only the processing time required from start to completion of the execution of the container application need be considered as the time to obtain the processing results of the container application. However, the computational resources of the on-board unit are limited, so when, for example, another computational process is also executed in parallel, the processing time of the container application is expected to become longer.

Furthermore, sometimes the processing speed of the on-board unit is reduced because of the state of the vehicle or the effects of the environment around the vehicle. For example, when the charge remaining in the vehicle's battery is low, sometimes the processing speed of the on-board unit is also reduced due to the on-board unit switching to a power saving mode or the like. Alternatively, when the vehicle is driving in a hot environment, in the same way sometimes the processing speed of the on-board unit is also reduced.

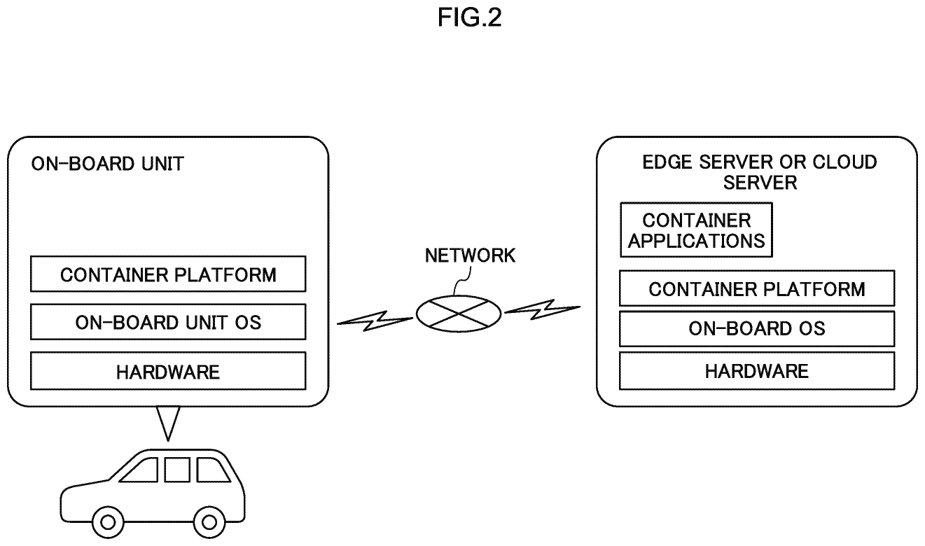

For this reason, as shown in FIG. 2, it is conceivable to solve the above problem by executing the container applications in a cloud server or an edge server. In this case, the cloud server or the edge server (hereinafter also simply called “the server”), like the on-board unit, has a container platform, an on-board unit OS, and hardware, and is configured to be capable of executing the container applications. The physical distance between the edge server and the on-board unit is shorter than the distance between the cloud server and the on-board unit. For this reason, the edge server is configured to be able to process data more in real time than the cloud server.

The server has advantages over the on-board unit in that its computing power is greater and the processing times of the container applications is shorter. However, in this case, the on-board unit and the server need to communicate with each other, and sometimes, because of that communication, it takes time to obtain the processing results. For example, the communication time differs depending on the signal strength between the on-board unit and the server or network traffic. Depending on the signal strength between the on-board unit and the server or network traffic, there is the potential for the communication time between the on-board unit and the server to be longer. For that reason, when executing the container applications in the server, a situation also arises where the on-board unit cannot immediately obtain the processing results.

Thus, an information processing system of this embodiment disposes the container in the device in which the time for obtaining the processing results of the container applications is the shortest and performs control so that the container applications are executed in that device.

Specifically, the information processing system of this embodiment determines, based on the processing time of a container application and the round-trip time (RTT) required for round-trip communication between the on-board unit and the cloud server or the edge server, which environment of any of the on-board unit, the cloud server, and the edge server it would be suitable to execute the container applications in. Then, the information processing system of this embodiment performs control to execute the container applications in the environment in which the processing results of the container applications are obtained the fastest.

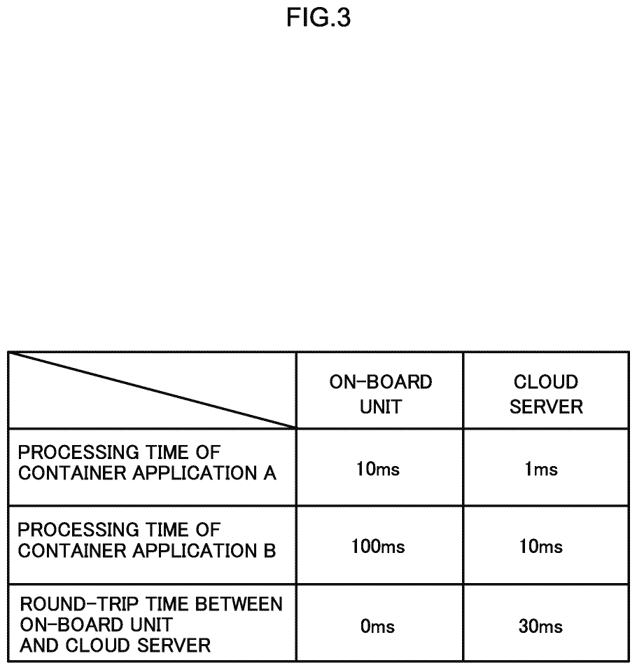

For example, suppose an example such as shown in FIG. 3. As shown in FIG. 3, suppose that the processing time is 10 ms if the on-board unit executes container application A, the processing time is 1 ms if the cloud server executes container application A, and the round-trip time between the on-board unit and the cloud server is 30 ms. In this case, whereas it takes 10 ms to obtain the processing results when the on-board unit executes container application A, it takes 31 ms for the on-board unit to obtain the processing results when the cloud server executes container application A. For this reason, in this case, the information processing system of this embodiment performs control to execute container application A in the on-board unit.

On the other hand, as shown in FIG. 3, suppose that the processing time is 100 ms if the on-board unit executes container application B, the processing time is 10 ms if the cloud server executes container application B, and the round-trip time between the on-board unit and the cloud server is 30 ms. In this case, whereas it takes 100 ms to obtain the processing results when the on-board unit executes container application B, it takes 40 ms for the on-board unit to obtain the processing results when the cloud server executes container application B. For this reason, in this case, the information processing system of this embodiment performs control to execute container application B in the cloud server. Because of this, the time required for the on-board unit to obtain the processing results of the container application can be shortened.

As mentioned above, the processing times of the container applications and the round-trip time between the on-board unit and the server fluctuate greatly depending on the location where the vehicle is positioned or the time. For this reason, the information processing system of this embodiment measures these times each time a predetermined amount of time elapses and performs control to execute the container applications in the environment in which the processing results of the container applications are obtained the fastest.

This is specifically described below.

(Information Processing System)

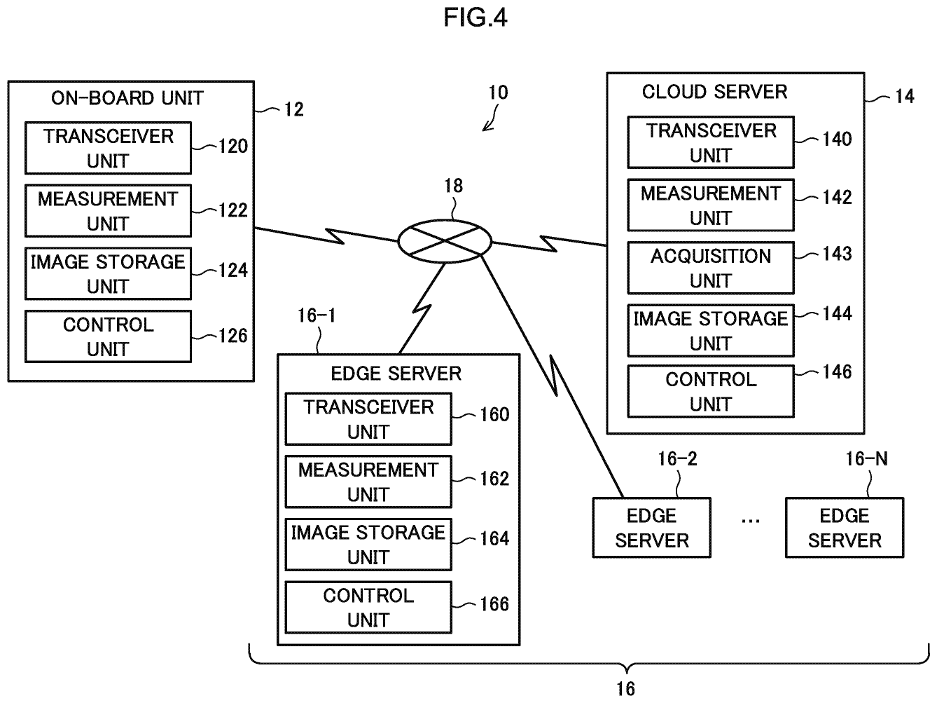

FIG. 4 is a block diagram showing an example of functional configurations of an information processing system 10 pertaining to the embodiment. As shown in FIG. 4, the information processing system 10 includes an on-board unit 12, a cloud server 14 that is an example of an information processing device, and a plurality of edge servers 16-1, 16-2, . . . , 16-N. Below, any one edge server among the plural edge servers 16-1, 16-2, . . . , 16-N is simply called “the edge server 16.” The on-board unit 12, the cloud server 14, and the edge server 16 are interconnected via a network 18 such as the Internet, for example.

(On-board Unit)

The on-board unit 12 executes a container application in accordance with allocation of the execution of the container application by the cloud server 14 described later. Alternatively, the on-board unit 12 receives the processing results of the container application executed by another environment such as the cloud server 14 or the edge server 16. As shown in FIG. 4, the on-board unit 12 includes a transceiver unit 120, a measurement unit 122, an image storage unit 124, and a control unit 126.

The transceiver unit 120 sends data to and receives data from the cloud server 14 or the edge server 16.

The measurement unit 122 measures, in response to a request signal output from the cloud server 14, the processing time in a case where the container application has been executed in the on-board unit 12.

The image storage unit 124 stores a container image that is data for executing the container application. The container image is an image file generated from the container that is being executed and includes data necessary for execution of the container application.

The control unit 126 reads the container image stored in the image storage unit 124 and executes the container application in accordance with the allocation of the execution of the container application by the cloud server 14.

(Cloud Server)

The cloud server 14 decides which environment to execute the container application in. As shown in FIG. 4, the cloud server 14 includes a transceiver unit 140, a measurement unit 142, an acquisition unit 143, an image storage unit 144, and a control unit 146.

The transceiver unit 140 sends data to and receives data from the on-board unit 12 or the edge server 16.

The measurement unit 142 measures the processing time in a case where the container application has been executed in the cloud server 14.

The acquisition unit 143 acquires the processing time in a case where the container application has been executed in the on-board unit 12. Furthermore, the acquisition unit 143 acquires the processing time in a case where the container application has been executed in the edge server 16. Furthermore, the acquisition unit 143 acquires the processing time, measured by the measurement unit 142, in a case where the container application has been executed in the cloud server 14.

When the container application is executed in the on-board unit 12, it is not necessary to acquire the processing results of the container application from another device, so it is not necessary to consider the round-trip time between the on-board unit 12 and the other device.

However, when the container application is executed in a server such as the cloud server 14 or the edge server 16, the on-board unit 12 needs to acquire the processing results via the network 18. For this reason, when the container application is executed in the server, it is necessary to consider the round-trip time between the on-board unit 12 and the server.

For that reason, when the container application is executed in the on-board unit 12, the acquisition unit 143 acquires, as a first time, the processing time in a case where the container application has been executed in the on-board unit 12. The first time is also a quality indicator relating to the execution of the container application by the on-board unit 12.

On the other hand, when the container application is executed in a server such as the cloud server 14 or the edge server 16 for example, the acquisition unit 143 calculates the sum of the round-trip time required for round-trip communication between the on-board unit 12 and the server and the processing time in a case where the container application has been executed in that server. The acquisition unit 143 also acquires, as a second time, the sum of the round-trip time and the processing time in regard to each of the plural servers. The second time is set in regard to each of the plural servers including the cloud server 14 and the edge server 16. The second time is also a quality indicator relating to the execution of the container application by the server.

The image storage unit 144 stores a container image that is data for executing the container application.

The control unit 146 decides which of the on-board unit 12, the cloud server 14, and the edge server 16 to execute the container application in. The control unit 146 also performs control to execute the container application in the device that has been decided as the device in which to execute the container application. Specifically, the control unit 146 identifies the shortest time from the first time and the second times in regard to each of the plural servers acquired by the acquisition unit 143 and performs control to execute the container application in the device corresponding to the shortest time.

Because of this, the time required to obtain the processing results of the container application can be shortened.

(Edge Server)

The edge server 16 executes the container application in accordance with the allocation of the execution of the container application by the cloud server 14. As shown in FIG. 4, the edge server 16 includes a transceiver unit 160, a measurement unit 162, an image storage unit 164, and a control unit 166.

The transceiver unit 160 sends data to and receives data from the on-board unit 12 or the cloud server 14.

The measurement unit 162 measures, in response to a request signal output from the cloud server 14, the processing time in a case where the container application has been executed in the edge server 16.

The image storage unit 164 stores a container image that is data for executing the container application.

The control unit 166 reads the container application stored in the image storage unit 164 and executes the container application in accordance with the allocation of the execution of the container application by the cloud server 14.

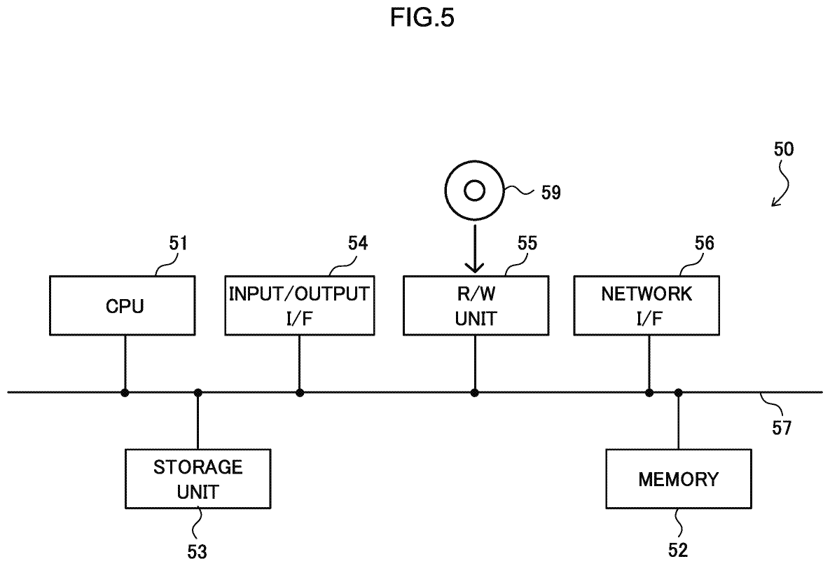

The on-board unit 12, the cloud server 14, and the edge server 16 can each be realized by, for example, a computer 50 such as shown in FIG. 5. The computer 50 for realizing the on-board unit 12, the cloud server 14, and the edge server 16 includes a central processing unit (CPU) 51, a memory 52 serving as a temporary storage space, and a nonvolatile storage unit 53. The computer 50 also includes an input/output interface (I/F) 54, to which input/output devices and the like (not shown in the drawings) are connected, and a read/write (R/W) unit 55 that controls the reading of data from and the writing of data to a recording medium 59. The computer 50 also includes a network I/F 56 connected to a network such as the Internet. The CPU 51, the memory 52, the storage unit 53, the input/output I/F 54, the R/W unit 55, and the network I/F 56 are connected to each other via a bus 57.

The storage unit 53 can be realized by a hard disk drive (HDD), a solid-state drive (SSD), or a flash memory, for example. A program for allowing the computer to function is stored in the storage unit 53, which serves as a storage medium. The CPU 51 reads the program from the storage unit 53, transfers it to the memory 52, and sequentially executes processes that the program has.

Next, the action of the information processing system 10 of the embodiment will be described.

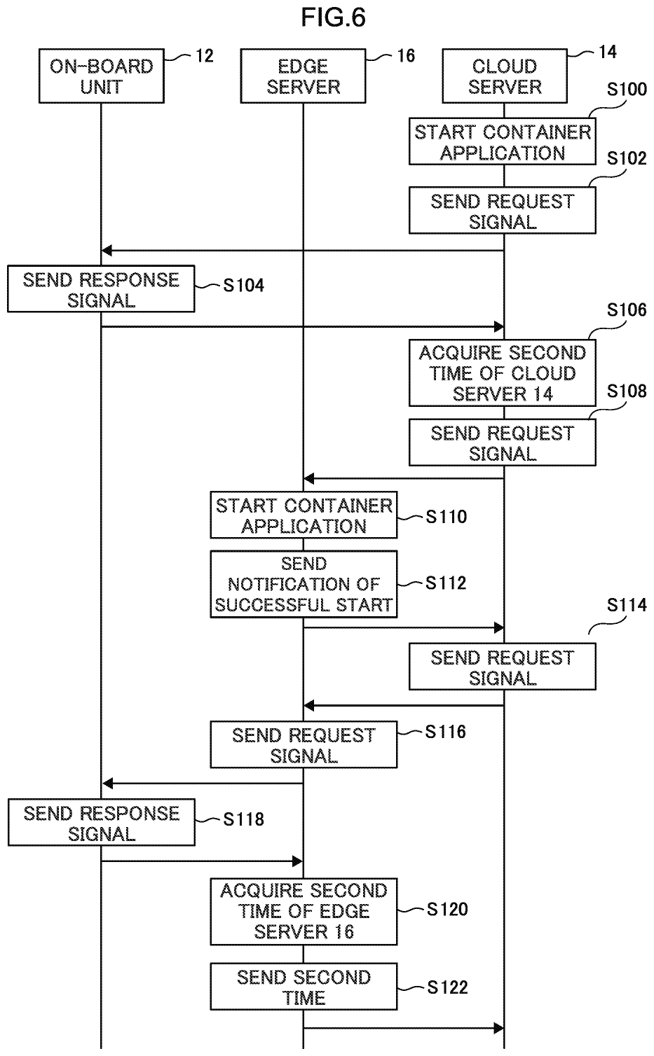

When the cloud server 14 of the information processing system 10 receives an instruction signal to start a process to control the execution of the container application, execution of sequences shown in FIG. 6 to FIG. 11 is started. Below, the device to which the container application has been allocated will also be called “the deployment environment.”

The information processing system 10 of this embodiment selects an initial deployment environment representing the device in which a subject container application is to be initially executed, and thereafter executes the container application in that initial deployment environment. Then, after the container application has been executed in the initial deployment environment, each time a predetermined amount of time elapses, the information processing system 10 selects a redeployment environment representing the deployment environment in which the container application is to be executed. This is specifically described below.

FIG. 6 to FIG. 8 are sequences executed when selecting the initial deployment environment.

In step S100, the control unit 146 of the cloud server 14 reads the subject container image from its own image storage unit 144 and executes the container application. At this time, the measurement unit 142 of the cloud server 14 acquires the time when the execution of the container application was started. Then, when the execution of the container application is completed, the measurement unit 142 of the cloud server 14 acquires the time when the process of the container application was completed.

In step S102 the control unit 146 of the cloud server 14 sends a request signal to the on-board unit 12 via the transceiver unit 140. The request signal is a signal requesting the control unit 146 to send back a response signal.

In step S104 the transceiver unit 120 of the on-board unit 12 receives the request signal sent from the cloud server 14 in step S102 and sends to the cloud server 14 a response signal in response to the request signal.

In step S106 the transceiver unit 140 of the cloud server 14 receives the response signal sent from the on-board unit 12 in step S104.

Furthermore, in step S106 the acquisition unit 143 of the cloud server 14 acquires the round-trip time required for round-trip communication between the on-board unit 12 and the cloud server 14 based on the time of the request signal sent in step S102 and the reception time of the response signal received in step S106. Furthermore, in step S106 the acquisition unit 143 of the cloud server 14 acquires the processing time of the container application based on the start time and the completion time of the container application measured by the measurement unit 142 of the cloud server 14.

Additionally, in step S106 the acquisition unit 143 of the cloud server 14 acquires the second time of the cloud server 14 by calculating the sum of the round-trip time between the on-board unit 12 and the cloud server 14 and the processing time of the container application.

In step S108 the control unit 146 of the cloud server 14 sends a request signal to the edge server 16 via the transceiver unit 140. The request signal is a signal requesting the edge server 16 to start the container application.

In step S110 the transceiver unit 160 of the edge server 16 receives the request signal sent from the cloud server 14 in step S108. Furthermore, the control unit 166 of the edge server 16 reads the container image of the subject container application from the image storage unit 164 and executes the container application. At this time, the measurement unit 162 of the edge server 16 acquires the time when the execution of the container application was started. Then, when the execution of the container application is completed, the measurement unit 162 of the edge server 16 acquires the time when the process of the container application was completed.

In step S112 the transceiver unit 160 of the edge server 16 sends to the cloud server 14 a notification that the container application was successfully started.

In step S114 the control unit 146 of the cloud server 14 sends a request signal to the edge server 16 via the transceiver unit 140. The request signal is a signal requesting the edge server 16 to calculate the second time of the edge server 16.

In step S116 the control unit 166 of the edge server 16 sends a request signal to the on-board unit 12 via the transceiver unit 160. The request signal is a signal requesting the on-board unit 12 to send back a response signal.

In step S118 the transceiver unit 120 of the on-board unit 12 receives the request signal sent from the edge server 16 in step S116 and sends to the edge server 16 a response signal in response to the request signal.

In step S120 the transceiver unit 160 of the edge server 16 receives the response signal sent from the on-board unit 12 in step S118.

Furthermore, in step S120 the control unit 166 of the edge server 16 acquires the round-trip time between the on-board unit 12 and the edge server 16 based on the time of the request signal sent in step S116 and the response signal received in step S120. Furthermore, in step S120 the control unit 166 of the edge server 16 acquires the processing time of the container application based on the start time and the completion time of the container application measured by the measurement unit 162 of the edge server 16.

Additionally, in step S120 the control unit 166 of the edge server 16 acquires the second time of the edge server 16 by calculating the sum of the round-trip time between the on-board unit 12 and the edge server 16 and the processing time of the container application.

In step S122 the control unit 166 of the edge server 16 sends the second time to the cloud server 14 via the transceiver unit 160.

Although only one edge server is shown in FIG. 6, in reality the cloud server 14 acquires second times in regard to each of the plural edge servers.

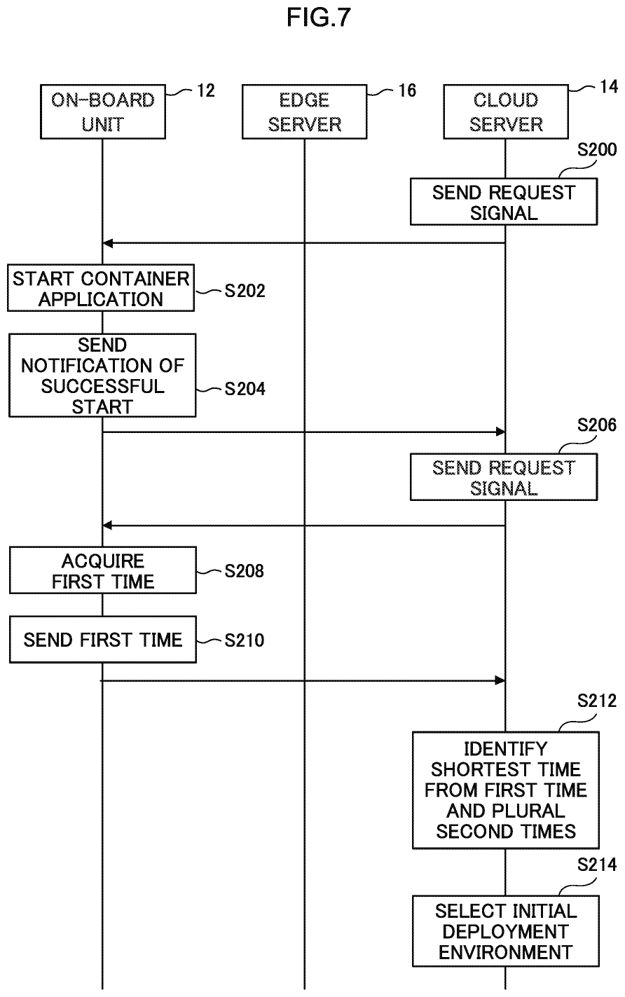

Next, in step S200 of FIG. 7 the control unit 146 of the cloud server 14 sends a request signal to the on-board unit 12 via the transceiver unit 140. The request signal is a signal requesting the on-board unit 12 to start the container application.

In step S202 the transceiver unit 120 of the on-board unit 12 receives the request signal sent from the cloud server 14 in step S200. Furthermore, the control unit 126 of the on-board unit 12 reads the container image of the subject container application from the image storage unit 124 and executes the container application. At this time, the measurement unit 122 of the on-board unit 12 acquires the time when the execution of the container application was started. Then, when the execution of the container application is completed, the measurement unit 122 of the on-board unit 12 acquires the time when the process of the container application was completed.

In step S204 the transceiver unit 120 of the on-board unit 12 sends to the cloud server 14 a notification that the container application was successfully started.

In step S206 the control unit 146 of the cloud server 14 sends a request signal to the on-board unit 12 via the transceiver unit 140. The request signal is a signal requesting the on-board unit 12 to acquire the first time of the on-board unit 12.

In step S208 the control unit 126 of the on-board unit 12 acquires the first time representing the processing time of the container application based on the start time and the completion time of the container application measured by the measurement unit 122 of the on-board unit 12.

In step S210, the control unit 126 of the on-board unit 12 sends the first time to the cloud server 14 via the transceiver unit 120.

In step S212 the transceiver unit 140 of the cloud server 14 receives the first time sent from the on-board unit 12. Furthermore, in step S212 the control unit 146 of the cloud server 14 identifies the shortest time from the first time of the on-board unit 12, the second times in regard to each of the plural edge servers 16, and the second time of the cloud server 14.

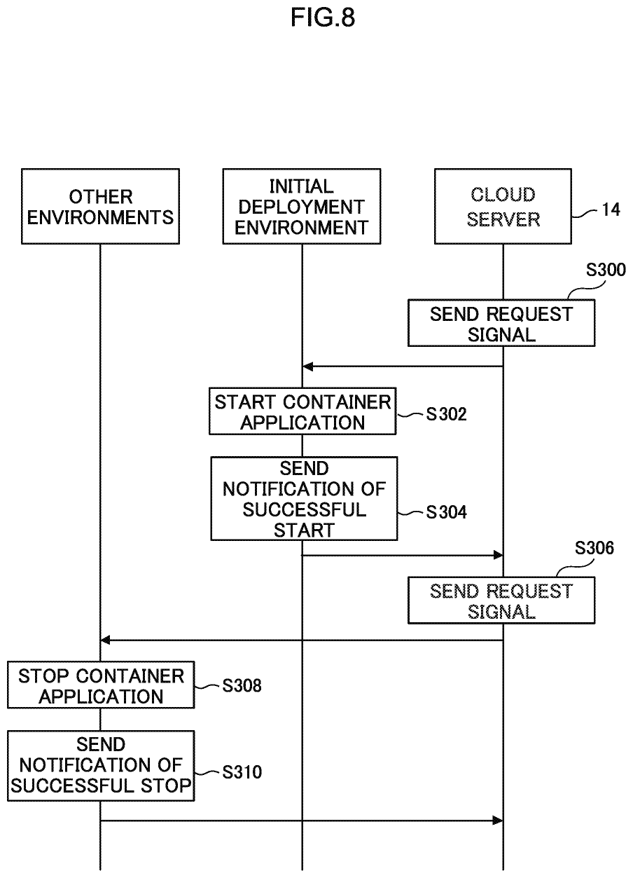

In step S214 the control unit 146 of the cloud server 14 selects, as the initial deployment environment, the device corresponding to the shortest time identified in step S212. Additionally, the control unit 146 of the cloud server 14 performs control to execute the container application in the initial deployment environment. Specifically, the control unit 146 of the cloud server 14 executes the sequence shown in FIG. 8.

In step S300 the control unit 146 of the cloud server 14 sends a request signal to the device corresponding to the initial deployment environment via the transceiver unit 140. The request signal is a signal requesting the initial deployment environment to start the container application.

The initial deployment environment is any one device among the on-board unit 12, the edge server 16, and the cloud server 14. In a case where the initial deployment environment is the cloud server 14, the control unit 146 of the cloud server 14 reads the container image from its own image storage unit 144 and executes the container application without sending a request signal to an external device.

In step S302 the device corresponding to the initial deployment environment receives the request signal sent from the cloud server 14. Additionally, in step S302 the device corresponding to the initial deployment environment reads the container image from its own image storage unit and starts the container application.

In step S304 the device corresponding to the initial deployment environment sends to the cloud server 14 a notification that the container application was successfully started.

Next, the control unit 146 of the cloud server 14 performs control to stop the container application in each of the devices different from the initial deployment environment in which the container application is executed.

Specifically, in step S306 the control unit 146 of the cloud server 14 sends a request signal to the other devices (indicated as “other devices” in the drawing) different from the initial deployment environment via the transceiver unit 140. The request signal is a signal requesting the other devices to stop the container application.

In step S308 the other devices different from the initial deployment environment receive the request signal sent from the cloud server 14. Additionally, in step S308 the other devices different from the initial deployment environment stop the container application.

In step S310 the other devices different from the initial deployment environment send to the cloud server 14 a notification that they have stopped the container application.

In this way, the cloud server 14 selects the initial deployment environment and performs control so that the container application is executed in the initial deployment environment.

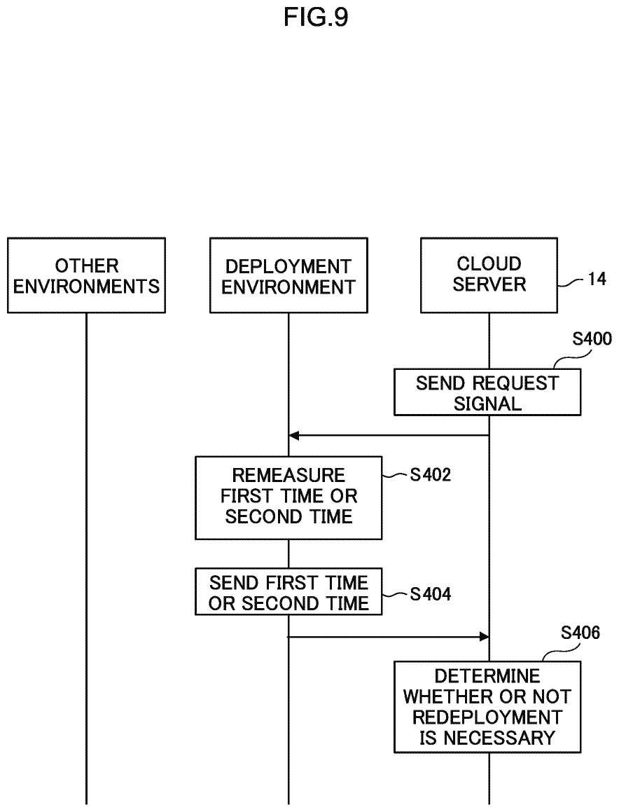

Next, when a predetermined amount of time elapses since the selection of the initial deployment environment, execution of the sequences shown in FIG. 9 to FIG. 11 is started. Specifically, each time a predetermined amount of time elapses, the cloud server 14 acquires the first time of the on-board unit 12 and the second times in regard to each of the plural servers and performs control to execute the container application in the device corresponding to the shortest time.

In step S400 of FIG. 9 the control unit 146 of the cloud server 14 sends a request signal to the deployment environment via the transceiver unit 140. The request signal is a signal requesting the device corresponding to the deployment environment to calculate the first time or the second time.

In step S402 the device corresponding to the deployment environment receives the request signal sent from the cloud server 14 in step S400. Additionally, in step S402 the device corresponding to the deployment environment acquires the first time or the second time. In a case where the deployment environment is the on-board unit 12, the first time is measured again. In a case where the deployment environment is the edge server 16, the second time is measured again.

In step S404 the device corresponding to the deployment environment sends to the cloud server 14 the first time or the second time measured in step S402.

In step S406 the transceiver unit 140 of the cloud server 14 receives the first time or the second time sent from the device corresponding to the deployment environment. Additionally, in step S406 the control unit 146 of the cloud server 14 determines whether or not a redeployment to execute the container application in a device different from the device corresponding to the deployment environment is necessary.

For example, the control unit 146 of the cloud server 14 determines that a redeployment is necessary in a case where the first time or the second time remeasured in step S402 is equal to or greater than a predetermined threshold.

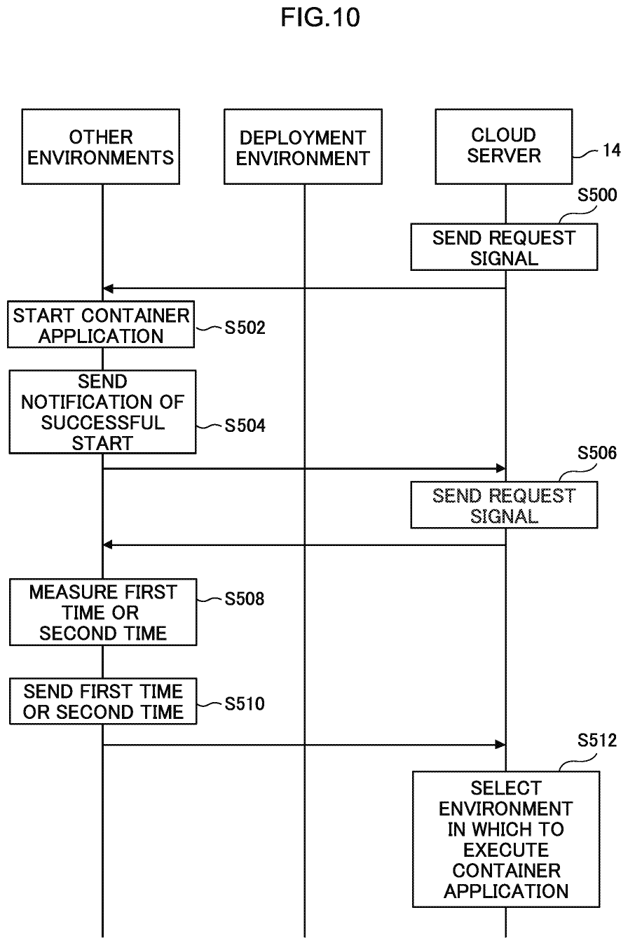

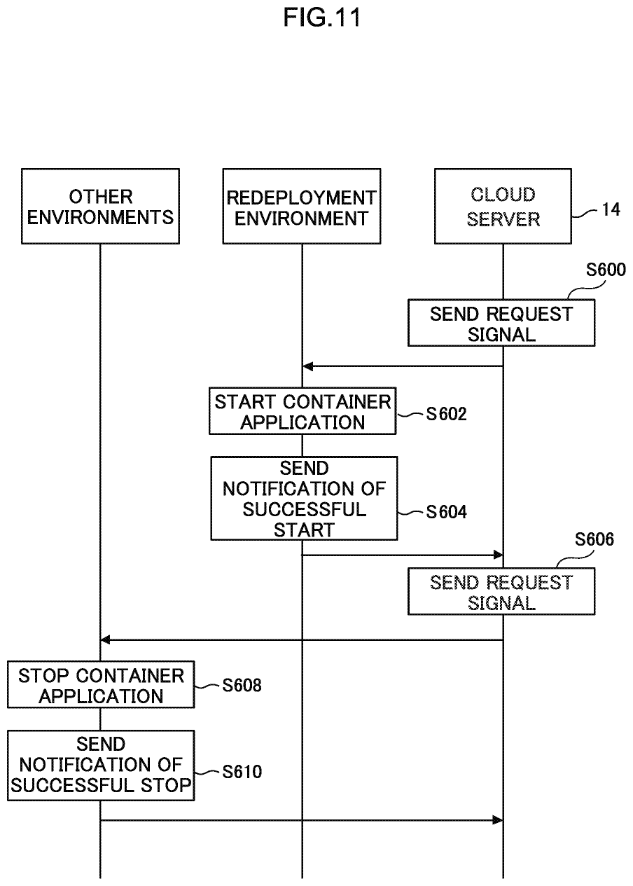

In a case where it has been determined by the cloud server 14 that a redeployment is necessary, the sequences shown in FIG. 10 and FIG. 11 are executed.

In step S500 the control unit 146 of the cloud server 14 sends a request signal to each of the devices different from the deployment environment via the transceiver unit 140. The request signal is a signal requesting the devices different from the deployment environment to start the container application.

In step S502 each of the devices different from the deployment device receives the request signal sent from the cloud server 14 in step S500. Additionally, in step S502 each of the devices different from the deployment environment reads the container image from its own image storage unit and starts the container application. At this time, the measurement unit of each of the devices different from the deployment environment acquires the time when execution of the container application was started. Then, when the execution of the container application is completed, the measurement unit acquires the time when the process of the container application was completed.

In step S504 each of the devices different from the deployment environment sends to the cloud server 14 a notification that the container application was successfully started.

In step S506 the control unit 146 of the cloud server 14 sends a request signal to each of the devices different from the deployment environment via the transceiver unit 140. The request signal is a signal requesting the devices different from the deployment environment to calculate the first time or the second time.

In step S508 each of the devices different from the deployment environment receives the request signal sent from the cloud server 14 in step S506. Additionally, in step S508 each of the devices different from the deployment environment measures the first time or the second time.

In step S510 each of the devices different from the deployment environment sends to the cloud server 14 the first time or the second time measured in step S508.

In step S512 the transceiver unit 140 of the cloud server 14 receives the first time or the second time sent from each device in step S510. Additionally, in step S512 the control unit 146 of the cloud server 14 identifies the shortest time from the first time of the on-board unit 12, the second times in regard to each of the edge servers 16, and the second time of the cloud server 14. Then, the control unit 146 of the cloud server 14 sets, as the redeployment environment, the device corresponding to the shortest time and performs control to execute the container application in the redeployment environment.

In step S600 shown in FIG. 11, the control unit 146 of the cloud server 14 sends a request signal to the device corresponding to the redeployment environment via the transceiver unit 140. The request signal is a signal requesting the redeployment environment to start the container application.

In step S602 the device corresponding to the redeployment environment receives the request signal sent from the cloud server 14 in step S600. Additionally, in step S602 the device corresponding to the redeployment environment reads the container image from its own image storage unit and starts the container application.

In step S604 the device corresponding to the redeployment environment sends to the cloud server 14 a notification that the container application was successfully started.

In step S606 the control unit 146 of the cloud server 14 sends a request signal to each of the devices corresponding to the other environments different from the redeployment environment via the transceiver unit 140. The request signal is a signal requesting the other devices different from the redeployment environment to stop the container application.

In step S608 the other devices different from the redeployment environment receive the request signal sent from the cloud server 14. Additionally, in step S608 the other devices different from the redeployment environment stop the container application.

In step S610 the other devices different from the redeployment environment send to the cloud server 14 a notification that they have stopped the container application.

As described above, the cloud server of the information processing system 10 pertaining to the embodiment acquires the first time representing the processing time in a case where the container application has been executed by the on-board unit. The cloud server also acquires the second times in regard to each of the plural servers including the cloud server and the edge servers, each of the second times being calculated from the sum of the processing time in a case where the container application has been executed by the server and the round-trip time required for round-trip communication between the on-board unit and the server. The cloud server identifies the shortest time from the second times in regard to each of the plural servers and the first time of the on-board unit and performs control to execute the container application in the device corresponding to the shortest time. Because of this, the time required to obtain the processing results of the container application can be shortened in consideration of the processing time required for execution of the container application and the round-trip time between the vehicle and the server.

Furthermore, each time a predetermined amount of time elapses, the cloud server of this embodiment acquires the first time of the on-board unit and each of the second times in regard to each of the plural servers and performs control to execute the container application in the device corresponding to the shortest time. Because of this, even in a case where the round-trip time between the on-board unit and the server and the processing time of the container application change in accordance with the external environment, execution of the container application can be continued while shortening the time for obtaining the processing results of the container application.

Although the processes performed by each device in the above embodiment were described as software processes performed by executing programs, the processes may also be performed by hardware. Alternatively, the processes may also be performed by a combination of both software and hardware. Furthermore, the program stored in the ROM may also be stored in various types of storage media and circulated.

Moreover, this disclosure is not limited to what is described above and of course can be modified in various ways and implemented, in addition to what is described above, in a range that does not depart from the spirit of the disclosure.

For example, in the above embodiment, a case where the cloud server 14 decides the device in which to execute the container application was described as an example, but the disclosure is not limited to this. For example, any one edge server among the plural edge servers 16 may also have the function of the cloud server 14 of the above embodiment.

All publications, patent applications, and technical standards mentioned in this specification are herein incorporated by reference to the same extent as if each individual publication, patent application, or technical standard was specifically and individually indicated to be incorporated by reference.

What is claimed is:

1. An information processing device comprising a memory and a processor coupled to the memory, the processor being configured to:
acquire a first time representing processing time in a case in which a container application has been executed by an on-board unit and acquire second times in regard to each of a plurality of servers communicable with the on-board unit, each of the second times being calculated from a sum of processing time in a case in which the container application has been executed by a server and round-trip time required for round-trip communication between the on-board unit and the server; and
identify a shortest time from the second times in regard to each of the plurality of servers and the first time of the on-board unit and perform control to execute the container application in a device corresponding to the shortest time.

2. The information processing device of claim 1, wherein the processor performs control to stop the container application in each of the devices different from the device in which the container application is executed.

3. The information processing device of claim 1, wherein each time a predetermined amount of time elapses, the processor acquires the first time and each of the second times and performs control to execute the container application in the device corresponding to the shortest time.

4. The information processing device of claim 1, wherein the processor acquires the round-trip time of each device by requesting the round-trip time from each device and thereafter uses the round-trip time of each device to calculate the first time and the second times.

5. An information processing method performed by a processor, the method comprising:
acquiring a first time representing processing time in a case in which a container application has been executed by an on-board unit and acquiring second times in regard to each of a plurality of servers communicable with the on-board unit, each of the second times being calculated from a sum of processing time in a case in which the container application has been executed by a server and round-trip time required for round-trip communication between the on-board unit and the server; and
identifying a shortest time from the second times in regard to each of the plurality of servers and the first time of the on-board unit and performing control to execute the container application in a device corresponding to the shortest time.

6. A recording medium storing an information processing program executable by a processor to perform a process, the process comprising:
acquiring a first time representing processing time in a case in which a container application has been executed by an on-board unit and acquiring second times in regard to each of a plurality of servers communicable with the on-board unit, each of the second times being calculated from a sum of processing time in a case in which the container application has been executed by a server and round-trip time required for round-trip communication between the on-board unit and the server; and
identifying a shortest time from the second times in regard to each of the plurality of servers and the first time of the on-board unit and performing control to execute the container application in a device corresponding to the shortest time.

7. An information processing system comprising an on-board unit and a plurality of servers communicable with the on-board unit, wherein:
a processor, with which the on-board unit is equipped, outputs, to a cloud server among the plurality of servers, a first time representing processing time in a case in which a container application has been executed by the on-board unit;
each of processors with which each of the plurality of servers is equipped outputs, to the cloud server, a second time calculated from a sum of processing time in a case in which the container application has been executed by a server and round-trip time required for round-trip communication between the on-board unit and the server; and
a processor with which the cloud server is equipped acquires the first time of the on-board unit and the second times in regard to each of the plurality of servers, identifies a shortest time from the second times in regard to each of the plurality of servers and the first time of the on-board unit, and performs control to execute the container application in a device corresponding to the shortest time.
